(19) United States
(12) Patent Application Publication
(10) Pub. No.: US 2012/0024765 A1
(43) Pub. Date: Feb. 2, 2012

(54) FILTERING CORE FOR FLUID

(76) Inventor: Cheng-Hsiong Chen, Taichung (TW)

(21) Appl. No.: 13/189,550

(22) Filed: Jul. 24, 2011

(30) Foreign Application Priority Data
Jul. 27, 2010 (TW) 099214229

(51) Int. Cl. B01D 35/00

(52) U.S. Cl. 210/85

(57) ABSTRACT

The present invention discloses a filtering core for fluid, which includes main body and several identify portion. The main body is used to filter fluid. The identify portion are different from one another on color. Their colors are also different from the original color of the main body. When the main body accumulates a certain amount of contaminants, and changes its original color to a second color, the user may match this second color with the closest color on one of the identify portion. Then, he may decide if he needs to replace the filtering core, or wash the main body. This would help the user to enhance the precision judgment on deciding the time to replace the filtering core.

### FIELD OF THE INVENTION

The present invention relates to a filtering core for fluid, and more in particular to a technique which provides users to identify the service life of the filtering core so that the user may decide when he needs to replace or wash the filtering core.

### BACKGROUND OF THE INVENTION

The filtering core is installed inside the water filter to filter fluid like liquid or water. Most of the users replace or wash the filtering core depending on the usage duration. In fact, the disposal of the filtering core should be based on the amount of the contaminants to be absorbed. Furthermore, the environment at each place is different on contaminating status. Therefore, the replacement time of filtering core should be different. The conventional filtering core doesn't have a design which provides a reference of replacement time. The replacement is just based on the usage duration. It may cause a waste due to early replacement.

In view of above defect, there is a prior design which reminds the user of the contaminant absorbing degree in filtering material, such as Taiwanese Utility Patent No. M253408 for a filter net. The filter net is made of color cotton film and the filter cotton under high temperature hot pressing. The color cotton film is provided with a color area and an uncolored area. When the color in uncolored area becomes dark for being contrasted with the color area, the user may judge if it is the time for replacing the filter net. However, the defects of this patent are: (a) The flat filter net can filter only the contaminants in the air; (b) The replacement of the filter net is based on the difference between the color area and the uncolored area. It is not easy to make a precise comparison and judgment only depending on the difference of two colors; (c) Neither the color area nor the uncolored area can suggest the user doing a perfect disposal because no information is provided about the types of the contaminants absorbed by the filter net.

### SUMMARY OF THE INVENTION

The purpose of the present invention is to provide an identify portion for color comparison so as to simplify the identification of replacing the filtering core. The technical means includes one main body and several identify portion. The identify portion have different colors, which are different from the original color of the main body. When the main body accumulates a certain amount of contaminants after filtering liquid, and changes its original color to a second color, the user may match the second color with the colors on the identify portion, and decide if he needs to replace the filtering core of the main body.

### BRIEF DESCRIPTION OF THE DRAWINGS

FIG. 1 is a 3D drawing of the filtering core of the present invention;

FIG. 2 is a side view of the filtering core structure of the present invention;

FIG. 3 is schematic drawing of the second embodiment of the present invention;

FIG. 4 is a schematic drawing of the third embodiment of the present invention;

FIG. 5 is a schematic drawing of the fourth embodiment of the present invention;

FIG. 6 is a 3D exploded view of the fifth embodiment of the present invention;

FIG. 7 is a 3D view of the sixth embodiment of the present invention;

FIG. 8 is a 3D view of the seventh embodiment of the present invention;

FIG. 9 is a 3D exploded view of the eighth embodiment of the present invention;

FIG. 10 is a 3D view of the ninth embodiment of the present invention;

FIG. 11 is a 3D view of another embodiment of the filtering core of the present invention;

FIG. 12 is a 3D view of another embodiment of the filtering core of the present invention;

FIG. 13 is a 3D view of the tenth embodiment of the present invention, and

FIG. 14 is a 3D view of the eleventh embodiment of the present invention.

### DETAILED DESCRIPTION OF THE PREFERRED EMBODIMENT

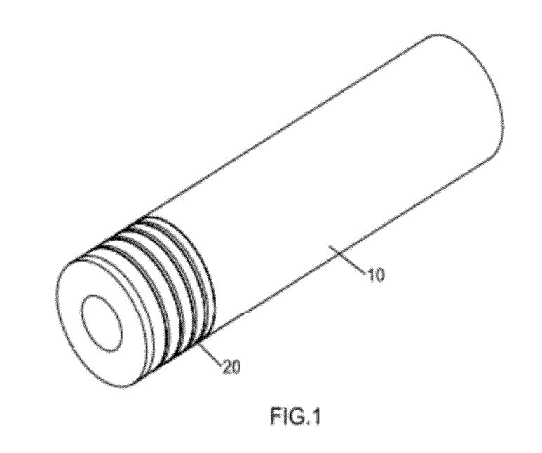

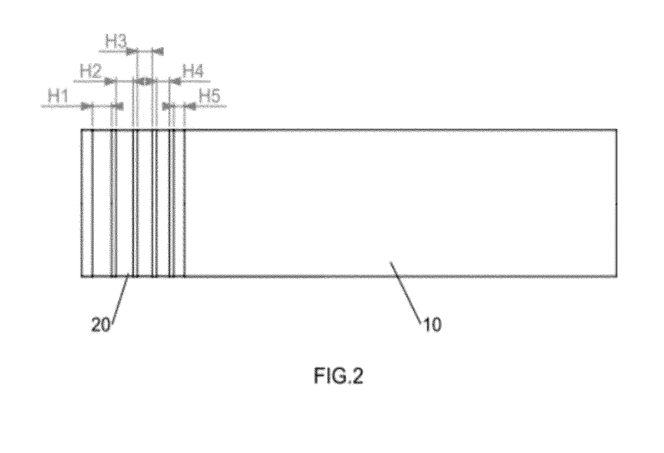

Referring to FIGS. 1 and 2, the filtering core of the present invention is used in a variety of filter utensils, drinking fountains, water purifying materials, or for water filtration. The filtering core includes a main body 10 and a plurality of identify portion 20. The main body 10 is in form of a column, and served as a filtering core to filter liquid. The filtering core is made of the filter materials which have absorbing and filtering functions, such as polypropylene, non-woven cloth, cotton cloth, foam sponge, filter net, filter paper, cotton fiber, filter bag, etc. . . . The main body 10 is ordinarily in form of a column, and is white. The identify portion 20 is provided at a position close to the main body 10, and can be printed, dyed, stuck or added on/to the place close to the main body 10. The plurality of the identify portion 20 is different from one another on color, and their colors are also different from one original color of the main body 10. When the main body 10 accumulates a certain amount of contaminants after filtering liquid, its original color will turn into a second color. The user may match the second color of the main body 10 with the closest color on one of identify portion, and decides if he needs to replace the main body 10.

Referring to FIGS. 1 and 2, there is a plurality of identify portion 20 longitudinally arranged in order along the main body 10, and each identify portion has a unique color. If the main body 10 is white, the colors of the plurality of the identify portion are of gray series from light grey to dark grey. If the main body 10 is light red, the colors of the plurality of the identify portion 20 are of red series from light red to dark red. The identify portion 20 are provided on top of the main body 10. The identify portion are provided on the main body 10 by means of printing, dyeing or sticking. Furthermore, there is a plurality of identify portion 20 with different longitudinal widths—H1, H2, H3, H4 and H5, along the main body 10. If the main body 10 is white, the main body 10 will change color gradually from white to grey, or even dark grey as the contaminants are increasing after the main body 10 filters liquid for a period of time. The user may match the color of the main body 10 with the colors of the identify portion, and decides if the main body needs a replacement or wash. Besides, based on the experience of using the first main body 10, the user may know the usage life of the first main body from installation to replacement. When next main body 10 changes its color to the similar replacement color of the first main body 10, the user may figure out an approximate usage life for the second main body 10.

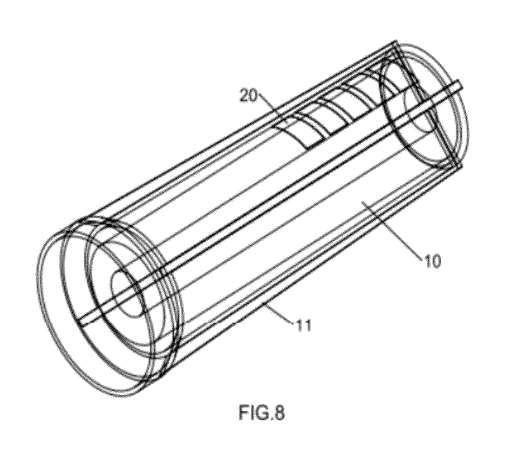

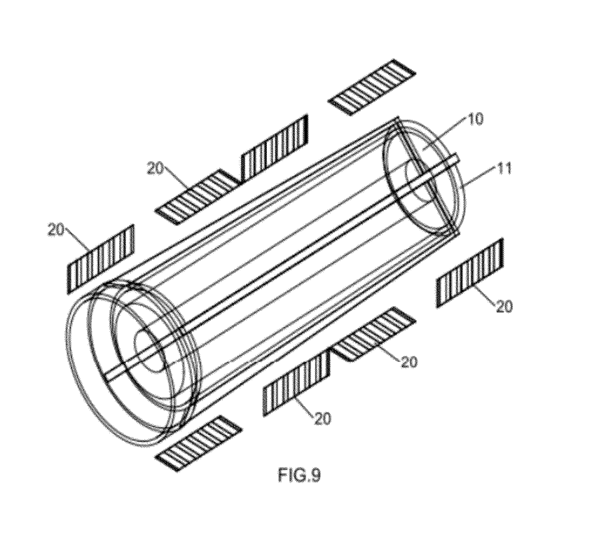

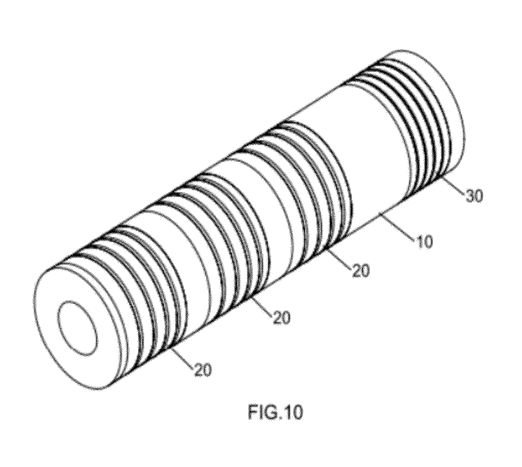

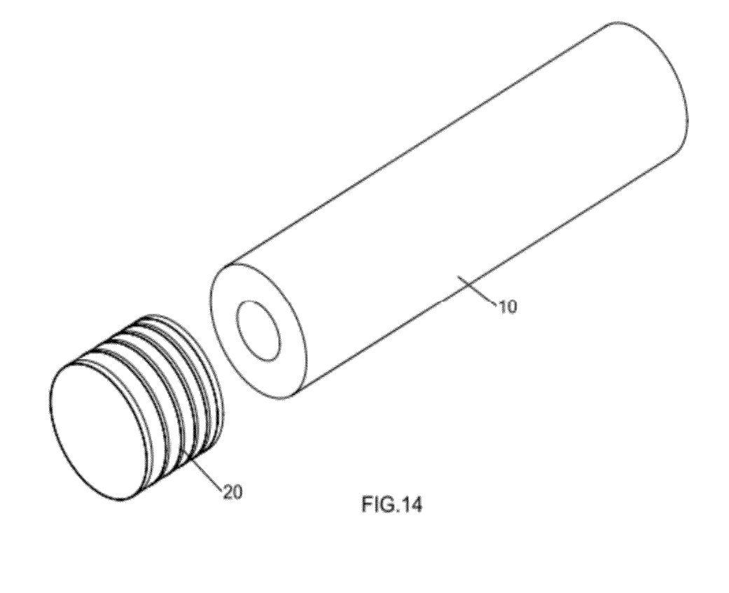

Referring to FIG. 8, the main body 10 is provided in a transparent tube body 11. The identify portion 20 are colored on the outside of the tube body 11. Referring to FIG. 14, the identify portion 20 can be a hot shrinking film or a cold shrinking film to be fixed on the main body 10 after being heated or cooled. Referring to FIG. 9, the main body 10 is provided in the transparent tube body 11, and the identify portion are stuck to the outside of the tube body 11.

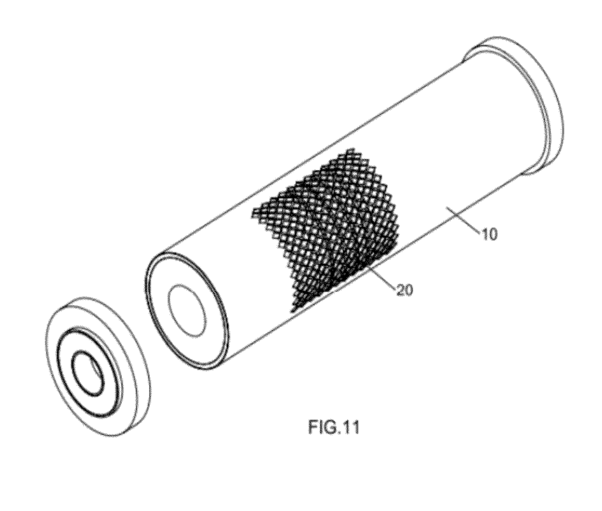

Referring to FIG. 10, there is a plurality of identify portion 20. Some of identify portion 20 are with colors from light grey to dark grey gradually. Some of the identify portion 20 are with colors from light red to dark red gradually, and some of the identify portion 20 are with colors from yellow to red gradually. No matter what liquid is filtered by this main body 10, there must be an identify portion 20 enough for color comparison and identification. Referring to FIG. 10, one end of the main body 10 is provided with a plurality of second identify portion 30 with colors different to one another for user's comparison with the second color of the main body 10. Each color on the second identify portion 30 stands for one kind of contaminant. If it is green, it means that the main body 10 might absorb more contaminants like algae or microbes. If it is brown, it means that the material absorbed by the main body 10 might be iron rust. If it is soil-like yellow, it means that the contaminants absorbed by the main body 10 might be sludge. If it is grey, it means that material absorbed by the main body 10 might be cement-like material.

Referring to FIGS. 1 and 2, the identify portion 20 are marked with digital values or words. There is a plurality of identify portion 20 longitudinally arranged along the main body 10. The identify portion 20 are provided with digital vales in decrease order.

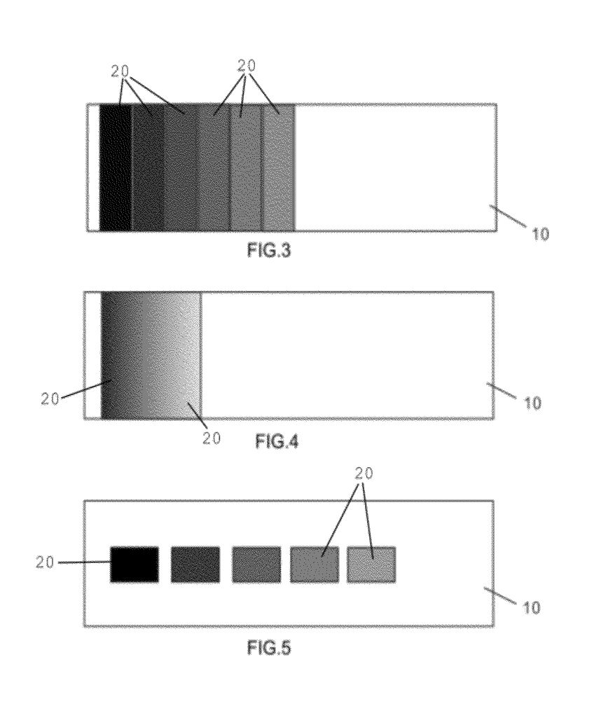

Referring to FIG. 3, one of the embodiments of the present invention has a plurality of identify portion 20 longitudinally arranged along the main body 10 with the same widths surrounding one neighbor end of the main body 10.

Referring to FIG. 4, one of the embodiments of the present invention has a plurality of identify portion 20 joining together to form one area surrounding the main body 10. The color of the plurality of the identify portion 20 changes gradually from light to dark.

Referring to FIG. 5, one of the embodiments of the present invention has a plurality of identify portion 2 in form of separate small areas arranged on one line.

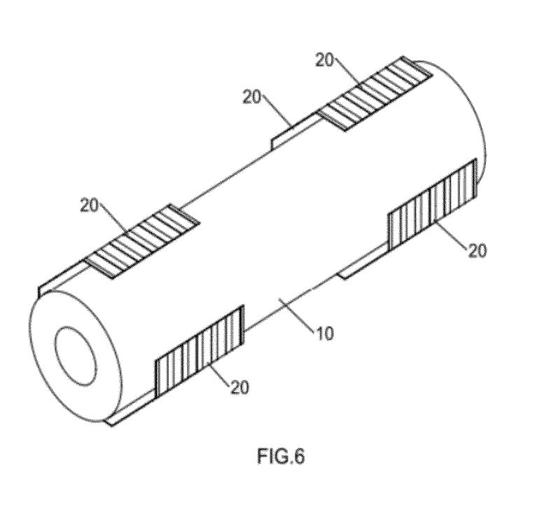

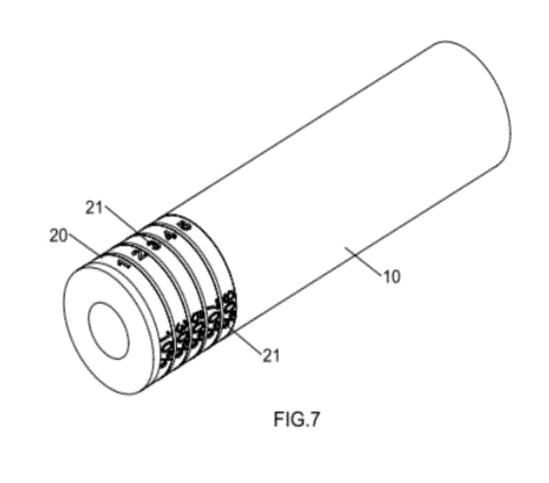

Referring FIG. 6, one of the embodiments of the present invention is in form of labels, tags or paper stickers stuck to the main body 10.

Referring to FIG. 7, one of the embodiments of the present invention has a plurality of identify portion 20 with indications 21 of digital value or words. If the indications 21 are digital values, the digital values are arranged in increase order to show the amount of the contaminants accumulated in the main body 10. It allows the user to clearly identify the amount of the contaminants in the main body 10. For embodiment, the 70% on the fourth circle stands for about 70% usage life of the main body 10.

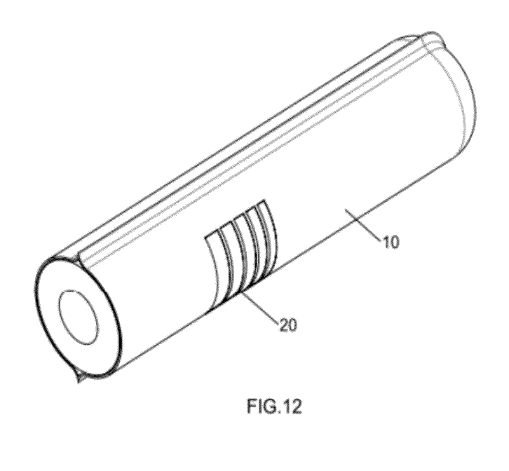

Referring to FIG. 11, the present invention is a filtering core structure. The main body 10 is designed with a multiple-layer structure. The outset layer is a mesh ring. Referring to FIG. 12, it is another filtering core structure of the present invention. The main body 10 has a multiple-layer structure. The outset layer is a filter bag which the identify portion 20 is provided on.

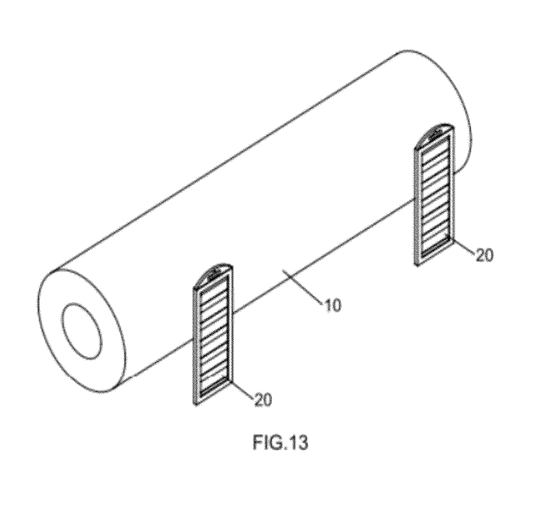

Referring to FIG. 13, it is one of the embodiments of the present invention. The identify portion 20 is provided with a tag on or close to the main body 10, as if it is hung on the filtering core frame or in the filtering core container.

The advantages of the present invention:

1. The present invention has a plurality of identify portion with different color tones from light to dark. It greatly enhances the accuracy of identifying the replacement time for the filtering core.

2. The identify portion can be a printing, a sticker or a tag. It won't change the original making procedure of the main body. It makes the production easier.

3. The ready-made filtering core sold in the market can be modified to make the identify portion with identification function. The production cost won't be increased much.

4. As the identify portion is made of stickers or tags, it can be installed at a place near the main body of the filtering core. It is easy to make the identify portion.

5. The identify portion of the present invention can be easily made, and fit a variety of brands of filtering cores and filter utensils.

6. The identify portion of the present invention can be quickly produced in large quantity by printing. It is easy to reduce cost.

7. The identify portion of the present invention has several color tones. A short text on the outer packing will allow the uses to easily understand its application.

8. The identify portion of the present invention is added with digital vales or words so that the user can clearly make a color comparison, and understand the amount of the contaminants in the main body.

9. The main body of the present invention is added with one second identify portion so that the user may identify the types and the sources of the dirt or the contaminants absorbed by the main body. It is helpful for the user to make a better subsequent cleaning or treatment.

While we have shown and described the embodiment in accordance with the present invention, it should be clear to those skilled in the art that further embodiments may be made without departing from the scope of the present invention.

What is claimed is:

1. A filtering core for fluid comprising:
a column-shaped main body being for filtering fluid; and
a plurality of identify portion being with different colors to one another, and their colors also being different from an original color of the main body; when the main body changing the original color to a second color after accumulating an amount of contaminants, the user matching the second color with the closest color on one of the identify portion, and deciding to replace or wash the main body.

2. The filtering core as claimed in claim 1, wherein the plurality of identify portion are longitudinally arranged along the main body

3. The filtering core as claimed in claim 1, wherein the main body is white, the colors of the plurality of the identify portion are of grey series from light grey to dark grey.

4. The filtering core as claimed in claim 1, wherein the main body is light red, and the colors of the identify portion are of red series from light red to dark red.

5. The filtering core as claimed in claim 1, wherein the identify portion are provided on the main body.

6. The filtering core as claimed in claim 1, wherein the identify portion can be printed or dyed on the main body, or stuck to the main body.

7. The filtering core as claimed in claim 1, wherein the main body is held in a transparent tube, and the plurality of identify portion are colored on the outside of the tube.

8. The filtering core as claimed in claim 1, wherein the identify portion are made of heat shrinking films, wrapping the main body after heat shrink.

9. The filtering core as claimed in claim 1, wherein the identify portion is made of cold shrinking film, wrapping the main body after being cooled.

10. The filtering core as claimed in claim 1, wherein some identify portions have colors from light grey to dark grey, some identify portions have colors from light red to dark red, and some identify portions have colors from light yellow to dark yellow.

11. The filtering core as claimed in claim 1, wherein the main body is provided with a plurality of second identify portion; the second identify portion have different colors for the user to make color comparison.

12. The filtering core as claimed in claim 1, wherein digital values or words are marked on the plurality of identify portion respectively.

13. The filtering core as claimed in claim 12, wherein the plurality of identify portion longitudinally arranged along the main body; digital values in decrease order are provided on the plurality of the identify portion.

14. The filtering core as claimed in claim 1, wherein the plurality of identify portion with different longitudinal widths along the main body.
